(19) United States
(12) Patent Application Publication
(10) Pub. No.: US 2026/0223787 A1
(43) Pub. Date: Aug. 6, 2026

(54) DELIVERY ASSEMBLIES AND RELATED METHODS FOR USE IN INJECTING FLUIDS INTO PLANTS

(71) Applicant: INVAIO SCIENCES, INC., CAMBRIDGE, MA (US)

(72) Inventors: James COVINO, Londonderry, NH (US); Thomas GERSTER, Zwingen (CH); Brandon MCGANNON, Cranberry, PA (US); Jason MIZGORSKI, Gibsonia, PA (US); Beat MÜLLER, Olsberg (CH); Carly SILVERNALE, Seattle, WA (US)

(21) Appl. No.: 19/464,496

(22) Filed: Jan. 29, 2026

Related U.S. Application Data
(60) Provisional application No. 63/753,382, filed on Feb. 3, 2025.
(60) Provisional application No. 63/855,270, filed on Jul. 31, 2025.

(51) Int. Cl. A01G 7/06

(52) U.S. Cl. CPC A01G 7/06

(57) ABSTRACT

Assemblies and methods are provided for injecting treatment fluids into plants. One example assembly includes a body, a container disposed within the body and configured to hold fluid to be dispensed into a plant, and a valve coupled in fluid communication to the container. The valve is configured to retain the fluid in the container. The assembly also includes a tip configured to couple in fluid communication to the container and actuate the valve to transfer the fluid from the container to the tip for discharge to the plant.

### CROSS-REFERENCE TO RELATED APPLICATIONS

This application claims the benefit of, and priority to, U.S. Patent Application No. 63/855,270, filed Jul. 31, 2025, and U.S. Patent Application No. 63/753,382, filed Feb. 3, 2025. The entire disclosure of each of the above applications is incorporated here by reference.

### FIELD

The present disclosure generally relates to assemblies and methods for use in delivering (e.g., injecting, etc.) treatment fluid (e.g., liquid formulations, etc.) into plants, and in particular, into trees (e.g., citrus trees, apple trees, palm trees, etc.).

### BACKGROUND

This section provides background information related to the present disclosure which is not necessarily prior art.

As part of the growth of plants, including, specifically, trees, disease is a factor in yield from the plants. Management practices are known to be introduced to limit the impact of disease in plants. As it relates to trees, for example, injectable fluid is known to treat disease in the trees. In connection with administration, a grower drills a hole into the tree, for example, to a specified depth, and uses a syringe to inject the fluid into the tree, such as into the heartwood of a tree trunk. Beyond treatments, the same method may be used to inject other formulations, such as, for example, insecticides, fungicides, nutrients or growth promoters, etc., into a plant.

### SUMMARY

This section provides a general summary of the disclosure, and is not a comprehensive disclosure of its full scope or all of its features.

Example embodiments of the present disclosure generally relate to delivery assemblies for coupling to plants and dispensing fluid into the plants. In one example embodiment, such a delivery assembly generally includes a body; a container disposed within the body and configured to hold fluid to be dispensed into a plant; a valve coupled in fluid communication to the container, the valve configured to retain the fluid in the container; and a tip configured to couple in fluid communication to the container and actuate the valve to transfer the fluid from the container to the tip for discharge to the plant.

Example embodiments of the present disclosure also generally relate to methods for delivering fluid into plants using fluid delivery assemblies. In one example, such a method generally includes positioning a container of the fluid delivery assembly within a body of the fluid delivery assembly; filling the container with the fluid, while the container is positioned within the body; installing a tip of the fluid delivery assembly to a plant; coupling the body to the tip, while the tip is installed to the plant; and in response to coupling the body to the tip, automatically dispensing the fluid in the container to the plant via the tip.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, and are not intended to limit the scope of the present disclosure.

FIG. 1 is a perspective view of an example embodiment of a delivery assembly of the present disclosure, for delivering treatment fluid to plants;

FIG. 2 is an exploded perspective view of the delivery assembly of FIG. 1;

FIG. 3 is a perspective view of a tube of the delivery assembly of FIG. 1 in an unexpanded state (or contracted state, etc.);

FIG. 4 is an enlarged fragmentary view of a cap and valve of the delivery assembly of FIG. 1, shown coupled to a body of the delivery assembly;

FIG. 5 is a perspective view of a tip of the delivery assembly of FIG. 1;

FIG. 6 is an enlarged fragmentary view of the cap and valve of the delivery assembly of FIG. 1, shown coupled to the body of the delivery assembly, and with the tip positioned within the cap;

FIGS. 7-9 illustrate additional example embodiments of tips that may be used with the delivery assembly of FIG. 1;

FIG. 10 is a perspective view of another example embodiment of a tip that may be used with the delivery assembly of FIG. 1;

FIGS. 11 and 12 are side elevation views of the tip of FIG. 10;

FIG. 13 is a top plan view of the tip of FIG. 10;

FIG. 14 is a bottom plan view of the tip of FIG. 10;

FIG. 15 is a longitudinal section view of the tip of FIG. 10;

FIG. 16 schematically illustrates another example embodiment of a delivery assembly of the present disclosure, for delivering treatment fluid to plants;

FIG. 17 illustrates example dimensions of the delivery assembly of FIG. 16; and

FIG. 18 is a fragmentary view of an example embodiment of a valve that may be used in the delivery assembly of FIG. 1.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

For injection of formulation into plants, and specifically, citrus trees, palm trees, etc., the manner of injection is important to the efficacy of the formulation. Safety protocols are also associated with certain formulations. In connection therewith, a delivery assembly may be ineffective based on the mode of failure of the device, or the complexity of the design. For example, where a certain delivery device includes a non-return membrane, which is held open by a connecting element, a break in the connecting element outside of the delivery assembly leaves the non-return membrane displaced which, in turn, permits the formation therein to continue to flow. In another example, where a common syringe is used to administer the formulation, flow of the formulation to the tree, for example, is uncontrolled and potentially improper for the formulation and/or the tree. Other delivery assemblies are designed in a manner that creates production complexities.

Uniquely, the apparatuses and methods herein provide for a delivery assembly optimized for the delivery of one or more fluids (e.g., one or more liquid formulations, etc.) to a plant, such as, for example, a tree (e.g., a citrus tree, an apple tree, a palm tree, etc.), a woody stemmed plant, etc. In addition, the apparatuses and methods herein provide for delivery of the one or more fluids directly to the xylem of the plant, which is located in the cambium (whereby a reservoir of fluid may not build in the plant). In contrast, traditional drill and syringe application methods only deliver fluid to the heartwood (inactive/dead wood) of the plant. The heartwood then holds a reservoir of the fluid, which means the fluid can be detected long after the delivery/treatment. Further, as indicated above, the apparatuses and methods herein do not create a reservoir of fluid in the plant, such that the fluid can be administered closer to fruit harvest than in traditional methods.

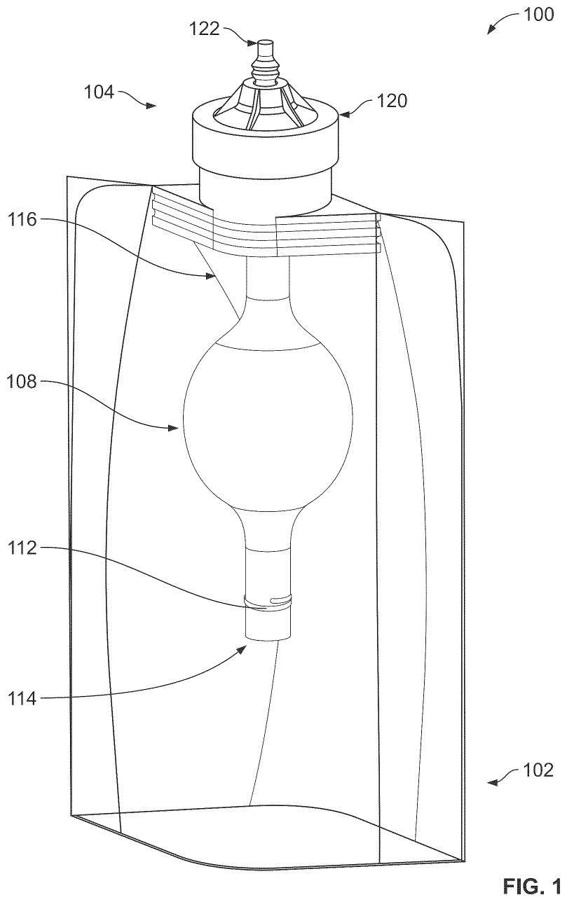

FIGS. 1-6 illustrate an example embodiment of a delivery assembly 100 including one or more aspects of the present disclosure. The delivery assembly 100 is configured to deliver one or more desired fluids to a plant (e.g., a tree, etc.). For instance, the delivery assembly 100 may be coupled to the plant and then actuated to deliver (e.g., inject, etc.) the fluid(s) to/into the plant (e.g., sequentially, simultaneously, etc.). In one example, the delivery assembly 100 may be installed to a plant and actuated at the same time to deliver the fluid(s) to/into the plant.

In connection therewith, the fluid(s) may include, without limitation, disease treatment(s), insecticide(s), fungicide(s), nutrients, growth promoter(s), other formulations, combinations thereof, etc. In particular, example fluids (e.g., formulations, etc.) that may be administered to a plant by a delivery assembly as described herein include liquid formulations, emulsifiable concentrates, emulsions in water, suspension concentrates, suspensions in water, water-dispersed granules, solutions and fluids. Suitable formulations may be prepared, for example, by mixing one or more active agents with one or more suitable additives such as suitable extenders, solvents, liquid carriers, wetters, solubilizers, emulsifiers, dispersants, thickeners, adjuvants or the like. Suitable active agents are known and described, for example, in The Pesticide Manual (20th edition, Ed. Dr. J A Turner (2024)), which is incorporated by references herein. Suitable active agents include, but are not limited to, herbicides, fungicides, insecticides, bactericides, larvicides, acaricides, nematicides, plant growth regulators, biostimulants, repellants, and synergists. In some embodiments herein, a suitable liquid formulation may further comprise one or more safeners. Examples of suitable safeners include potassium carbonate, hydrated lime, or diammonium phosphate. In some embodiments, the active agent is a biological control agent, such as a bio-pesticide. Compared to conventional synthetic chemical pesticides, bio-pesticides are non-toxic, safe to use, and can have high specificity. Useful bio-pesticides that can be administered by a delivery assembly as described herein include antibodies against fungal target proteins or other proteins with antifungal activity such as defensins and/or proteinase inhibitors. Defensins may include, for example, NaDl, PhDIA, PhD2, TomdefZ, RsAFP2, RsAFPl, RsAFP3 and RsAFP4 from radish, DmAMPl from dahlia, MsDefl, MtDef2, CtAMPl, PsDl, HsAFPl, VaDl, VrD2, ZmESR6, Ah AMP 1 and AhAMP4 from Aesculus hippocatanum, AflAFP from alfalfa, NaD2, AX1, AX2, BSD1, EGAD1, HvAMPl, JI-2, PgDl, SD2, SoD2, WT1, pl39 and pl230 from pea. Proteinase inhibitors may include proteinase inhibitors from the following classes: serine-, cysteine-, aspartic- and metallo proteinase inhibitors and carboxypeptidases such as StPinlA (see, for example, U.S. Pat. No. 7,462,695) or Bovine Trypsin Inhibitor I-P. In certain embodiments, a suitable formulation is a liquid formulation. In certain embodiments, a suitable formulation comprises a water soluble active agent and water.

In certain embodiments, a liquid formulation administered to a plant by a delivery assembly as described herein comprises one or more antibiotics. In some variations, a liquid formulation comprises an aminoglycoside antibiotic, quinolone antibiotic, tetracycline antibiotic or any combination of the foregoing. Suitable antibiotics include, but are not limited to Streptomycin, Gentamicin, Oxytetracycline, and Oxolinic Acid. In some embodiments, a liquid formulation administered to a plant by a delivery assembly as described herein comprises Oxytetracycline or a salt thereof. In certain variations, the antibiotic formulation further comprises citric acid.

In some variations, a liquid formulation comprising one or more micronutrients that can be administered to a plant utilizing a delivery assembly as described herein. In some variations, the liquid formulation comprises zinc, copper, manganese, boron, sulfur, calcium, or iron, or any salt thereof, or any combination of the foregoing. In some embodiments herein, the liquid formulation further comprises citric acid. In certain variations, the citric acid is complexed with the micronutrient(s) in the formulation. In one variation, the citric acid is in the form of hydracids. In one variation, the liquid formulation comprises a mixture of copper and zinc complexed with citric acid (e.g., under the form of hydracids, etc.). In another variation, the liquid formulation comprises a mixture of zinc and manganese complexed with citric acid (e.g., under the form of hydracids, etc.). In yet other variations, the liquid formulation comprises a mixture of zinc, manganese and copper complexed with citric acid (e.g., under the form of hydracids).

Example plants with which the delivery assembly 100 may be used include trees, woody stemmed plants, etc. In particular, delivery assemblies as described herein can be applied to Arecaceae, Musaceae, and all types of woody plants, such as coniferous trees, deciduous trees, shrubs and woody vines. Plants that can benefit from application of the delivery assemblies as described herein may be selected from (without limitation) nut-producing trees (e.g., Cashew, Walnut, Almond, Pecan, Hazelnut, Pistachio, Macadamia, etc.), citrus trees (e.g., orange, tangelo, navel, lemon, lime, grapefruit, pomelo, mandarins etc.), fruit trees (such as pomes, stone fruits or soft fruits, for example, apples, pears, plums, peaches, cherries, fig, guava, mango, papaya, etc.), olive trees, shrubs (e.g., blueberries, blackberries, raspberry, cranberry, etc.), coffee plants, lauraceous plants (e.g., avocados), woody vines (e.g., grapes,), coconut, pineapple, cocoa, tea, banana, conifers (e.g., loblolly pine, slash pine, ponderosa pine, lodgepole pine, Monterey pine, Douglas-fir, Western hemlock, Sitka spruce, redwood), true firs (such as silver fir and balsam fir), cedars (such as Western red cedar and Alaska yellow-cedar), palm trees (e.g., Archontophoenix alexandrae (king Alexander palm), Arenga spp. (Dwarf sugar palm), Borassus flabellifer (Lontar palm), Brahea armata (blue hesper palm), Brahea edulis (Guadalupe palm), Butia capitate (pindo palm), Chamaerops humilis (European fan palm), Carpentaria spp (Carpenteria palm), Chamaedorea elegans (parlor palm), C. erupens (bamboo palm), C. seifrizii (reed palm), Chrysalidocarpus lutescens (areca palm), Coccothrinax argentata (silver palm), C. crinite (old man palm), Cocos nucifera (coconut palm), Elaeis guineensis (African oil palm), Howea forsterana (kentia palm), Livistona rotundifolia (round leaf fan palm), Neodypsis decaryi (triangle palm); Normanbya normanbi (Queensland black); Pinanga insignis; Phoenix canadensis (Canary Island date); Ptychosperma macarthuri (Macarthur palm); Rhopalostylis spp (shaving brush p.); Roystonea elata (Florida royal palm), R. regia Cuban (royal palm), Sabal spp (Cabbage/palmetto), Syagrus romanzoffiana (queen palm), Trachycarpus fortune (windmill palm), Trythrinax acanthocoma (spiny fiber palm), Washingtonia filifera (petticoat palm) and/or W. robusta (Washington/Mexican fan palm)), etc.

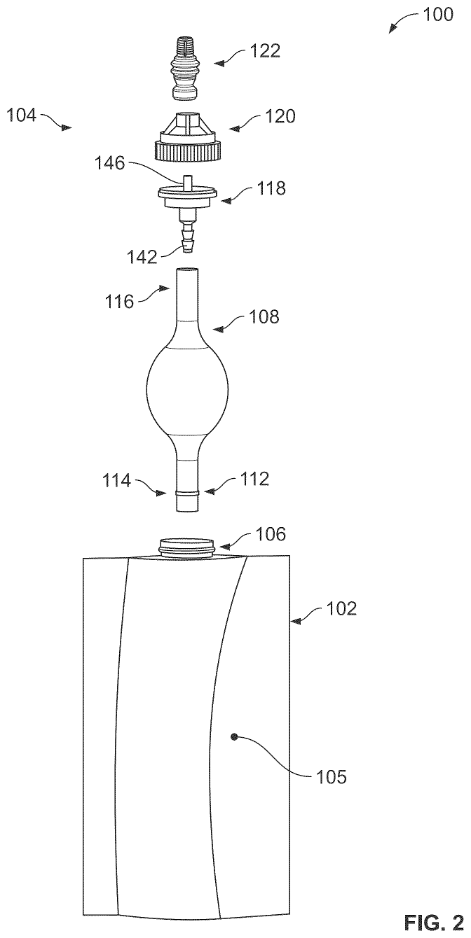

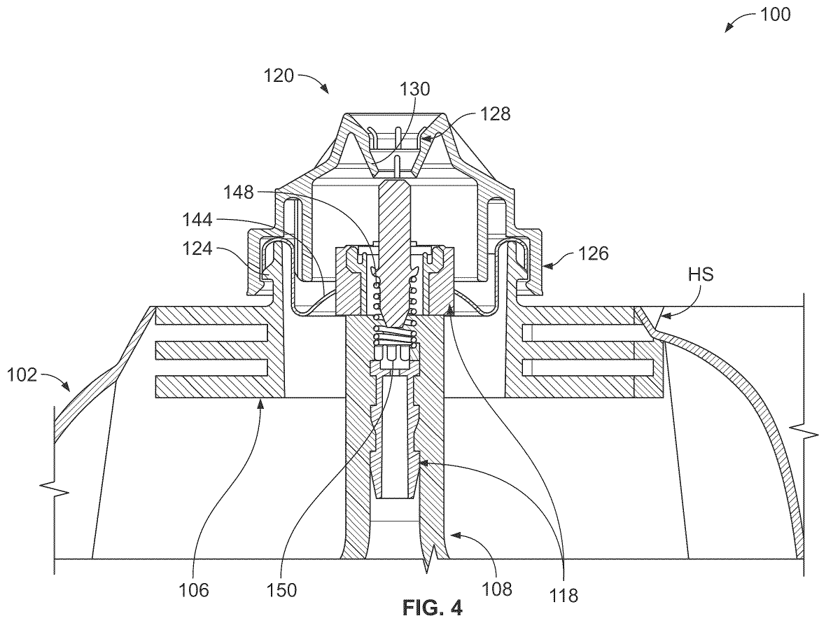

As shown in FIGS. 1 and 2, the delivery assembly 100 generally includes a body 102, and a dispensing unit 104 coupled to the body 102. The body 102 includes an outlet 106 (e.g., a spout, etc.) located at an end portion of the body 102 (e.g., heat sealed to/with the body 102 as shown at HS in FIG. 4, etc.). The dispensing unit 104, then, is coupled to the body 102 at the outlet 106. In addition, the body 102 may include an access point 105 to allow access to an interior of the body 102 (e.g., to fill a tube 108 of the dispensing unit with fluid while positioned in the body 102, etc.). In connection therewith, in various example embodiments, the body 102 may include a zipper positioned at the access point 105 (e.g., along a side portion of the body 102, etc.) to seal the access point 105 (when closed) and provide for selective access into the inner portion of the body 102 through the access point 105 (or access points 105) (when open).

In the illustrated embodiment, the body 102 is flexible (e.g., resiliently deformable, etc.) and includes (e.g., is illustrated as, etc.), for instance, an expandable, compressible, flexible, etc., pouch. The body 102 is configured to inhibit fluid disposed within the body 102 from leaking out of the body 102, and to inhibit the fluid and/or components of the dispensing unit 104 disposed within the body 102 from being damaged by exposure to ultraviolet light, etc. That said, the body 102 may be formed from suitable material (e.g., to achieve the above configurations of the body 102, etc.), including aluminum, nylon, polyethylene terephthalate (PET), low-density polyethylene (LDPE), combinations thereof, etc. In other example embodiments, the body 102 may have other configurations such as, for example, a rigid structure (e.g., a rigid canister, etc.), etc.

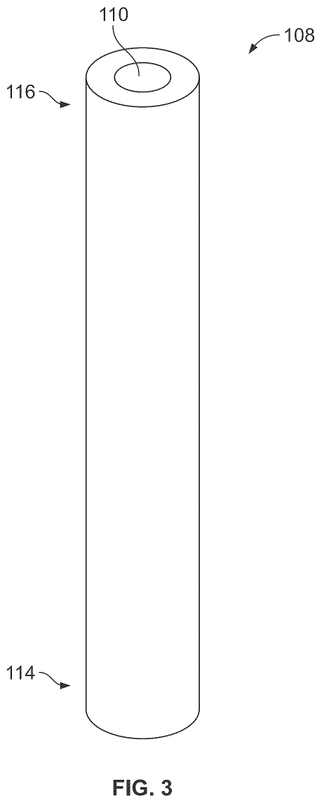

The dispensing unit 104 includes a tube 108 (e.g., a balloon, etc.) (broadly, a container), which is configured to be positioned within the body 102 and hold the fluid that is to be delivered to the plant (e.g., within an inner passage (or channel) 110 of the tube 108, etc.). In connection therewith, the tube 108 is expandable (e.g., resiliently expandable, etc.) (within the body 102) from a first state (see, e.g., FIG. 3) in which the tube 108 does not include the fluid to a second state (see, e.g., FIG. 1) in which the fluid is received in the inner passage 110 of the tube 108. Then, when the tube 108 is filled with fluid (in the second state), the resilient nature of the tube 108 causes (when desired) the fluid to discharge from the tube 108 (e.g., automatically, etc.), as the tube 108 deflates, retracts, contracts, etc., from the second (expanded) state back to the first state.

As such, the tube 108 can be positioned within the body 102 (in the unexpanded first state) and then filled with the fluid (to the expanded second state) (see, e.g., FIG. 1). A c-ring 112 is positioned around a first (lower) end portion 114 of the tube 108 (as viewed in FIGS. 1 and 2) to thereby seal the lower end portion 114 of the tube 108 so that it retains the fluid therein (i.e., in the inner passage 110) and inhibits the fluid from draining out of the tube 108 at the lower end portion 114. A second (upper) end portion 116 of the tube 108 (as viewed in FIGS. 1 and 2) is then coupled to a valve 118, which operates to selectively seal the upper end portion 116 of the tube 108 and inhibit the fluid from draining out of the tube 108 at the upper end portion 116 (when the valve 118 is closed) (e.g., via a seal configured to block flow of the fluid in the tube 108, etc.). In this way, once the tube 108 is filled with the fluid in the body 102 (and is in the second, expanded state), the valve 118 may be selectively opened and the resilient nature of the tube 108 causes the fluid therein to discharge through the valve 118 (whereby the tube 108 then returns to the first, unexpanded state).

In this example embodiment, the valve 118 is an aerosol valve, in which, for example, pressure on an actuator depresses a stem thereof. This movement interrupts the sealing action of a gasket included therein and exposes the stem orifice (e.g., opening 150 (as indicated below), etc.), to the pressurized flow of the fluid in the tube 108, thereby opening the valve 118. When the actuator is released, a spring actuator 148 (as indicated below) returns the stem orifice to the sealed position, closing the valve 118. In addition, in this example embodiment, the valve 118 may include, for example, without limitation, any suitable aerosol vales, such as valves provided from: Aptar at aptar.com/products/food-beverage/aerosol-valve/ or Majesty at www.majestyvalve.com/solutiontechnical.aspx, etc. Other suitable aerosol and non-aerosol valves may be employed in other delivery assembly embodiments.

In addition, in this example embodiment the valve 118 is configured as a return, two-way valve. As such, the fluid (to be included in the but 108) may be loaded into the tube 108 through the valve 118, for example, by depressing the stem of the valve 118 against the spring actuator 148. In doings so, the sealing action of the gasket included in the valve 118 (as discussed above) is interrupted, thereby exposing the opening 150 to the interior of the tube 108. The fluid may then be directed (or allowed to flow) into the tube 108, through the opening 150 (e.g., via a pressurized source of the fluid coupled to an outer portion of the valve 118, etc.). Once the tube 108 is filled with the fluid, as desired, the source of the fluid may be disconnected from the valve 118 whereby the spring actuator 148 returns the opening 150 to the sealed position (thereby closing the valve 118 and maintaining the fluid in the tube 108).

The tube 108 of the dispensing unit 104 may be formed from suitable material (e.g., to achieve the above configurations of the tube 108, etc.), including latex rubber, etc.

In this way, the material forming the tube 108 may (at least in part) contribute to the resilient nature of the tube 108, allowing it to transition between the first and second states described above. The tube 108 may also have different sizes, for example, depending on the implementation of the delivery assembly 100 (e.g., a volume of about 15 ml, about 30 ml, about 60 ml, about 120 ml, or more or less, etc.). In one example embodiment (without limitation), the tube 108 may have a volume of about 30 ml, a length of about 67 mm, an inner diameter of about 6 mm, and a wall thickness of about 3 mm. In another example embodiment (without limitation), the tube 108 may have a volume of about 6 ml, a length of about 73 mm, an inner diameter of about 6 mm, and a wall thickness of about 3 mm.

With additional reference to FIGS. 4-6, the dispensing unit 104 also includes a cap 120 (e.g., an actuator, etc.) and a tip 122 configured to couple to (and/or fit within and/or be inserted into) the cap 120 (e.g., releasably, etc.). In connection therewith, the cap 120 is configured to couple to the body 102 at the outlet 106. In the illustrated embodiment, the cap 120 is configured to snap-fit to the outlet 106. In particular, the outlet 106 includes a rim 124 extending therearound. And, the cap 120 includes a corresponding lip 126 (e.g., extending around the cap 120, etc.) configured to engage the rim 124 to thereby snap-fit (e.g., releasably snap-fit, etc.) the cap 120 to the outlet 106 and body 102. That said, it should be appreciated that the cap 120 may couple to the body 102 in other manners in other example embodiments (e.g., the cap 120 and the outlet 106 may include mating threads so that the cap 120 may be threaded onto the outlet 106, etc.).

In the illustrated embodiment, the tip 122 is configured to snap-fit to the cap 120 at an upper portion 128 of the cap 120. In connection therewith, the cap 120 includes a rim 130 (e.g., a deformable rim, etc.) extending around the upper portion 128. And, the tip 122 includes a corresponding bell portion 132 configured to mate with the rim 130, when the tip 122 is inserted into the upper portion 128 of the cap 120, to thereby couple (e.g., releasably secure, etc.) the tip 122 to the cap 120. In particular, when the tip 122 is inserted into the upper portion 128 of the cap 120, the bell portion 132 of the tip 122 is configured to resiliently deform the rim 130 and move past the rim 130 and into the cap 120. The rim 130 then moves back from the deformed position and engages the tip 122 generally above the bell portion 132 (e.g., to releasably secure the tip 122 on the cap 120, etc.). In the illustrated embodiment, the upper portion 128 of the cap 120 (and corresponding rim 130 extending therearound) include (or define) a generally conical shape. This shape may help facilitate alignment of the tip 122 (e.g., the bell portion 132 of the tip 122) with the cap 120 and the valve 118 disposed generally within the cap 120 (e.g., provides a generally self-alignment feature of the assembly 100, etc.). In other words, the conical shape of the upper portion 128 of the cap allows for (or accommodates, etc.) error in the alignment of the tip 122 with the valve 118 (when connecting the tip 122 to the cap 120), as the upper portion 132 of the tip 122 (and the corresponding rim 130) help direct the tip 122 into position over the cap 120 and valve 118 so that the cap 120 is easier to snap onto the tip 122, for example, after the tip 122 has been inserted into a tree, etc.

In example embodiments, the force required to remove (or separate) the tip 122 from the cap 120 (and rim 124 thereof) is greater than the force required to detach (or separate) the cap 120 from the outlet 106 of the body 102. In this way, the body 102 may be removed (or separated from) the dispensing unit 104 (e.g., once the delivery assembly 100 is installed in a tree, etc.). Another body (with different or additional fluid disposed therein) may then be attached to the dispensing unit 104 (and to the cap 120 thereof) to thereby allow for dispensing the additional fluid (from the second body) into the tree (via the existing dispensing unit 104 and tip 122 already coupled to the tree). Additionally, or alternatively, this force differential between the tip-cap interface and the cap-body interface may allow the cap 120 be used as leverage to remove the tip 122 from the tree (after the delivery assembly is installed in the tree. As such, in example embodiments, the force required to sperate the tip 122 from the cap 120 is greater than the force required to remove the tip 122 from the tree.

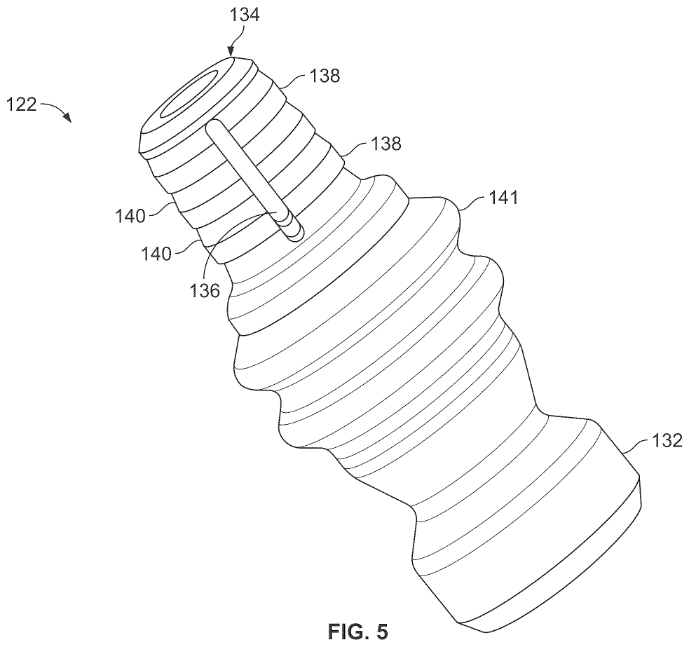

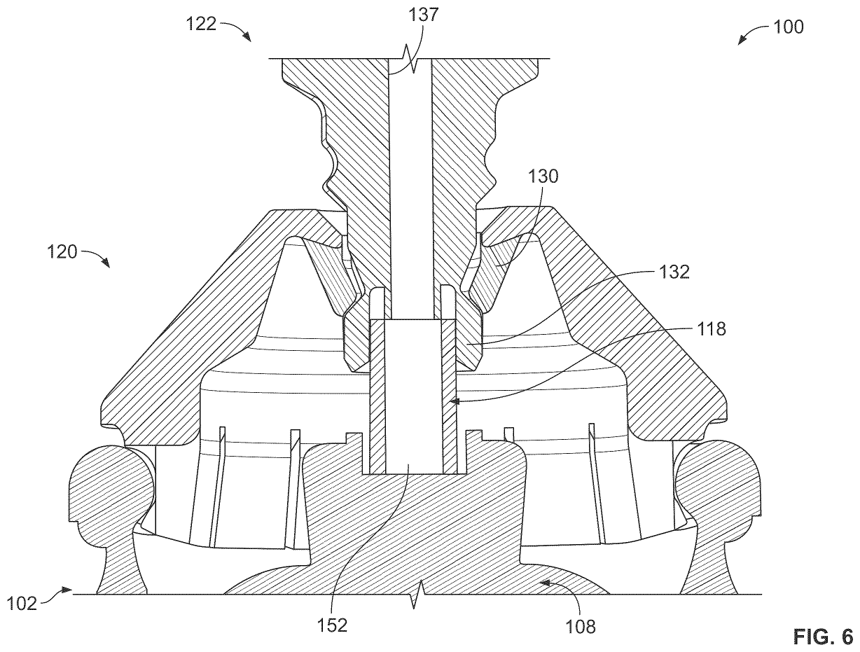

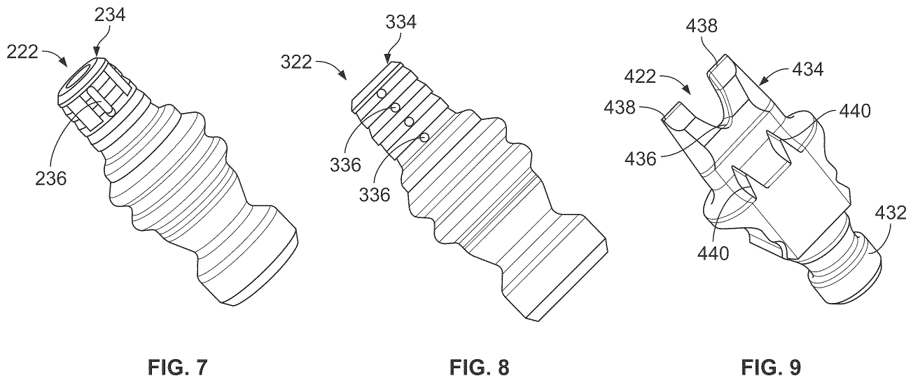

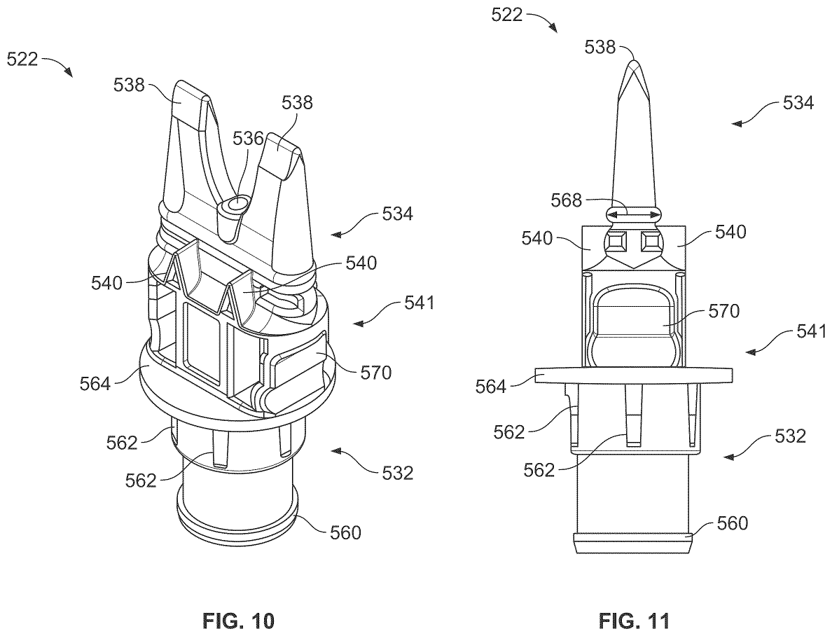

The illustrated tip 122 includes a head 134 (FIG. 5) configured to be inserted into a plant when desired to deliver the fluid from the tube 108 to the plant. In connection therewith, the head 134 includes a port 136 (broadly, and opening) (e.g., a slot, etc.) for discharging the fluid from the tip 122 and into the plant. In particular, the tip 122 is in fluid communication with the tube 108 (as described more hereinafter). As such, when desired, fluid is configured to flow from the tube 108 and into a channel 137 (FIG. 6) defined in the tip 122. The channel 137, then, is in fluid communication with the port 136, whereby the fluid is then discharged from the tip 122 at the port 136. In the illustrated embodiment, the head 134 has (or defines) a generally rounded and/or conical shape. It should be appreciated, though, that the head 134 may have other shapes in other embodiments of tips (see, e.g., FIGS. 9 and 10, etc.).

In addition, the head 134 of the illustrated tip 122 includes multiple ridges 138, and multiple valleys 140 disposed generally between the ridges 138 (FIG. 5). The ridges 138 are configured to contact (or engage) the plant when the tip 122 is inserted into the plant. The valleys 140, then, are in communication with the port 136 and are configured to carry the fluid discharged from the tip 122 (at the port 136) through the valleys 140 and to the plant (e.g., generally circumferentially around the tip 122, etc.). Further, the head 134 includes a flared base 141 configured to engage the plant when the tip 122 is inserted into the plant. In doing so, the base 141 is configured to form a seal between the head 134 and the plant to inhibit (e.g., prevent, limit, etc.) the fluid discharged from the tip 122 from leaking out of the plant (e.g., at the base 141, at a location where the tip 122 is inserted into the plant, etc.).

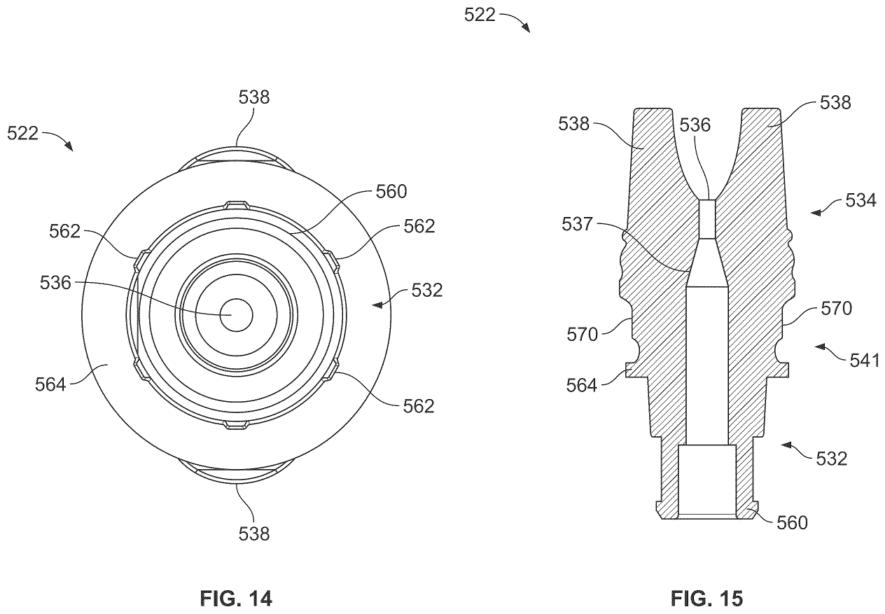

That said, FIGS. 7-15 illustrate example embodiments of additional tips 222, 322, 422, 522 that may be used in the delivery assembly of FIGS. 1-6. As shown in FIGS. 7 and 8, the tips 222, 322 are configured similar to the tip 122 described above (e.g., heads 234, 334 of the tips 222, 322 have/define generally rounded and/or conical shapes and include similar ridges and valleys as described for tip 122, etc.). For instance, the tip 222 includes a port 236 for delivering or discharging fluid from the tube 108 to the plant. And, the tip 322 includes multiple ports (or openings) 336 for delivering or discharging fluid from the tube 108 to the plant.

As shown in FIG. 9, the tip 422 includes a bell portion 432 configured to mate with the rim 130 of the cap 120, when the tip 422 is inserted into the upper portion 128 of the cap 120, to thereby couple (e.g., releasably secure, etc.) the tip 422 to the cap 120. In particular, when the tip 422 is inserted into the upper portion 128 of the cap 120, the bell portion 432 of the tip 422 is configured to resiliently deform the rim 130 and move past the rim 130 and into the cap 120. The rim 130 then moves back from the deformed position and engages the tip 422 generally above the bell portion 432 (e.g., to releasably secure the tip 422 on the cap 120, etc.).

The tip 422 of this embodiment also includes arms 438 and a central discharge port (or opening) 436 disposed between the arms 438. The arms 438 are configured to engage the plant (e.g., within an opening formed in the plant, etc.) and provide a space (between the arms 438) for the fluid to discharge from the discharge port 436 and to the plant (e.g., without the plant or other material blocking the discharge port 436, etc.). In this way, the fluid discharged from the discharge port 436 may engage a larger portion of the plant (e.g., within the opening formed in the plant, etc.), on generally either (or both) sides of head 434 of the tip 422 (e.g., on either or both the forward and rearward side of the head 434 as viewed in FIG. 9, etc.). In addition, the tip 422 includes multiple prongs 440 configured to engage the plant (e.g., within the opening formed in the plant, etc.) and help retain the tip 422 in the plant (e.g., secure the tip 422 within the plant by engaging, penetrating, etc., the plant). In addition in this embodiment, the head 434 of the tip 422 includes (or defines) a generally blade or wedge shape. In connection therewith, the prongs 440 also help inhibit (e.g., prevent, etc.) a weight of the body 102 and dispensing unit 104 from pulling the tip 422 from the plant (e.g., the prongs 440 may help counter a downward force on the delivery assembly 100 caused by the weight of the body 102 (and fluid therein) and dispensing unit 104, etc.).

With reference to FIGS. 10-15, the tip 522 of this embodiment again includes an end portion 532 configured to mate with the rim 130 of the cap 120 (of the dispensing unit 104), when the tip 522 is inserted into the upper portion 128 of the cap 120, to thereby couple (e.g., releasably secure, etc.) the tip 522 to the cap 120. In particular, in this embodiment, the end portion 532 includes a lip 560. As such, the when the tip 522 is inserted into the upper portion 128 of the cap 120, the lip 560 is configured to resiliently deform the rim 130 and move past the rim 130 and into the cap 120. The rim 130 then moves back from the deformed position and engages the end portion 532 of the tip 522 generally above (or behind) the lip 560 (e.g., along the end portion 532, etc.) (e.g., to releasably secure the tip 422 on the cap 120, etc.). The tip 522 is then in fluid communication with the dispensing unit 104 via channel 537 (FIG. 15).

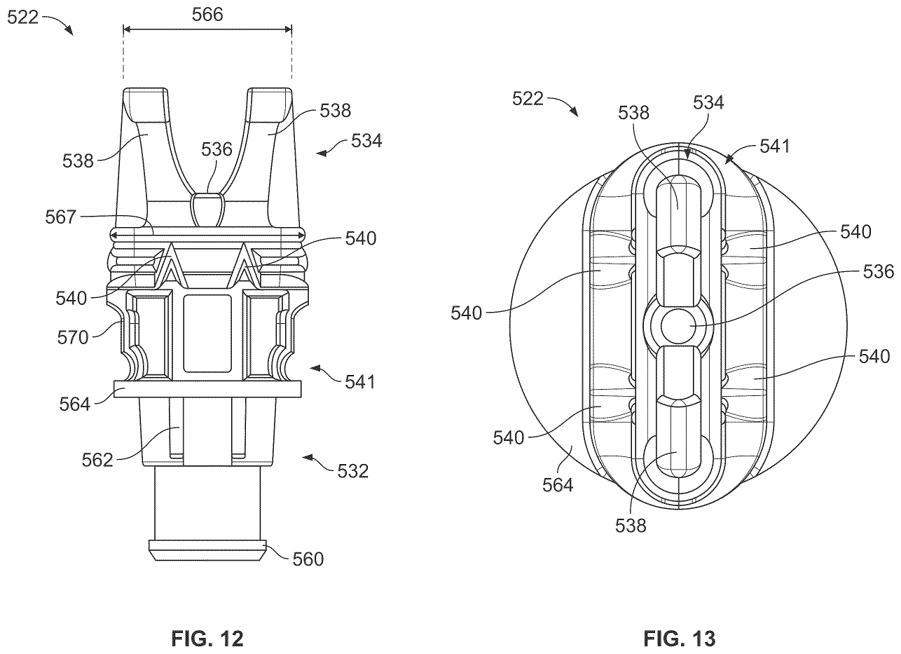

The tip 522 also includes a head 534 having arms 538 and a central discharge port (or opening) 536 disposed between the arms 538. The arms 538 are configured to engage the plant (e.g., within an opening formed in the plant, etc.) and provide a space (between the arms 538) for the fluid to discharge from the discharge port 536 (via the channel 537) and to the plant (e.g., without the plant or other material blocking the discharge port 536, etc.). In this way, the fluid discharged from the discharge port 536 may engage a larger portion of the plant (e.g., within the opening formed in the plant, etc.), on generally either (or both) sides of the head 534 of the tip 522 (e.g., on either or both the forward and rearward side of the head 534 as viewed in FIG. 12, etc.). In addition, the tip 522 includes multiple prongs 540 configured to engage the plant (e.g., within the opening formed in the plant, etc.) and help retain the tip 522 in the plant (e.g., secure the tip 522 within the plant by engaging, penetrating, etc., the plant).

Further in this embodiment, the head 534 of the tip 522 includes (or defines) a generally blade or wedge shape (in which widths 566, 567 of the tip 522 (as viewed in FIG. 12) are both greater than a thickness 568 of the tip 522 (as viewed in FIG. 11)) (e.g., the tip 522 is wider than it is thick, etc.). In connection therewith, the prongs 540 also help inhibit (e.g., prevent, etc.) a weight of the body 102 and dispensing unit 104 from pulling the tip 522 from the plant (e.g., the prongs 540 may help counter a downward force on the delivery assembly 100 caused by the weight of the body 102 (and fluid therein) and dispensing unit 104, etc.).

The tip 522 further includes a base 541 disposed generally between the end portion 532 and the head 534. In this embodiment, the base 541 includes multiple ribs 562 located around a perimeter of the base 541 and extending from a plateau 564 in a generally longitudinal direction of the tip 522 toward the end portion 532 (e.g., the ribs extend along an entire length (or at least part of the length) of the base 541 below the plateau 564, etc.). The illustrated ribs are also spaced generally equally around the perimeter of the base 541 (although this is not required in all embodiments). The ribs 562 are configured to engage the cap 120 (e.g., at or within the upper portion 128 of the cap 120, etc.) when the tip 522 is coupled to the cap 120. In doing so, the ribs 562 operate to provide additional support to the dispensing unit 104 (when coupled to a plant via the cap 120 and the tip 522) (e.g., a secure fit between the cap 120 and the tip 522, etc.) and to unload weight/force on the tip 522 from the dispensing unit 104 (e.g., the ribs 562 help secure the tip 522 to and/or stabilize the tip 522 in the dispensing unit 104, etc.). In turn, this inhibit (e.g., reduces, eliminates, etc.) sagging between the tip 522 and the cap 120 (and dispensing unit 104) that may be caused by the weight of the dispensing unit 104 (where such sagging may cause pressure on the valve 118 resulting in leaks from the dispensing unit 104, the cap 120, etc.). The base also includes a channel 570 (broadly, a recess or recessed area) along each of the sides of the tip 522 (e.g. the left and right sides of the tip 522 as viewed in FIG. 12, etc.). The channel 570 allows for grasping the tip when desired (e.g., for installing the tip 522 to the cap 120 of the dispensing unit 104, for installing the tip 522 to a plant, etc.).

Moreover, in this embodiment, a width of the head 534 generally increases in size from free ends of the arms 538 (as defined by outer edges of the arms 538) toward the base 541 (e.g., toward a base of the arms, etc.) (e.g., by about 1 mm, by about 2 mm, by about 3 mm, by about 5 mm, by about 10 mm, or more or less, etc.) (e.g., from about 9 mm to about 12.5 mm, from about 6.5 mm to about 12.5 mm, etc.). In other words, the head 534 (and corresponding arms 538) defines a generally tapered width (as viewed in FIG. 12) that is generally narrower at the free ends of the arms 538 (at a first width 566) and wider at the prongs 540 (e.g., where the arms 538 couple to (or engage) the base 541, etc.) (at a second width 567). As such, the width 567 of the head 534 is larger adjacent the base 541 (e.g., near the prongs 540, etc.) than the width 566 of the head 534 is at the free ends (or tips) of the arms 538. Such larger width of the head 534 (adjacent the prongs 540 and base 541), then, is configured to provide a seal between the tip 522 and the plant, when the tip 522 is inserted into the plant (e.g., into concaves or non-uniform surfaces of the plant, etc.). It should be appreciated that, in different embodiments of the tip 522, the head 534 may have different widths at the free ends of the arms 538 (e.g., about 5 mm, about 6 mm, about 6.5 mm, about 7 mm, about 9 mm, about 10 mm, etc.), while the width of the head 534 at the base 541 in the different embodiments may be the same (e.g., about 11 mm, about 11.5 mm, about 12 mm, about 12.5 mm, about 13 mm, etc.). As such, a degree of taper of the head 534 from the prongs 540 to the free ends of the arms 538 may be different in different embodiments of the tip 522 (depending on the width of the tip 522 at the free ends of the arms 538).

In general, the tips herein (e.g., tips 122, 222, 322, 422, 522, etc.), and their corresponding heads (e.g., heads 134, 234, 334, 434, 534, etc.) and ports (e.g., ports 136, 236, 336, 436, 536, etc.) formed in the heads, are configured to deliver fluid (e.g., liquid formulation, etc.) directly to the sapwood of the plant (e.g., tree, etc.) and not the heartwood. In some embodiments, the head of the tip has a length measured from a top of the head to a top of the bell portion, and the length is less than the expected thickness of sapwood in the plant targeted for injection with the tip. In some embodiments, the head is configured to engage the scion or rootstock of a plant (e.g., a tree, etc.) at a depth of about 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, or 15 mm. In some embodiments, the head is configured to dispense fluid at depth of about 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, or 15 mm. In some embodiments, the depth of the discharge ports/openings is selected based on scion diameter. In some embodiments, the head is configured to engage the scion or rootstock of a plant having a scion diameter less than about 6 cm at a depth of about 4 mm, 4.5 mm, 5 mm, 5.5 mm, 6 mm, 6.5 mm, 7 mm, or 7.5 mm. In some embodiments, the head is configured to engage the scion or rootstock of a plant having a scion diameter greater than about 6 cm at a depth of about 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, or 15 mm.

In connection with the above, it can be appreciated that the tips herein (e.g., tips 122, 222, 322, 422, 522, etc.) are configured to be minimally invasive to plants and to deliver fluid to vasculature of the plants. The tips also help eliminate pooling and/or settling of the fluid in the plants, for example, to ensure the health of the hardwood. This is accomplished by the added features o the tips described above, which help promote cyclic flow of the fluid from the tips to the plants and limit the open space around the tips, etc. In addition, the unique geometry and sealing features of the tips herein helps inhibit fluid from flowing back to the cambia of the plant, thereby limiting damage and promoting plant healing.

With reference again to FIGS. 2, 4, and 6, the valve 118 is disposed generally within the cap 120, between the tube 108 and the tip 122. The valve 118 is configured to control flow of fluid from the tube 108 to the tip 122 (when the tip 122 is coupled to the cap 120) (e.g., selectively block and unblock a flow path of fluid from the tube 108 to the tip 122, etc.). In particular, the valve 118 is configured to allow flow from the tube 108 to the tip 122 (e.g., open the flow path, etc.), when actuated (or opened), but to inhibit flow from the tube 108 to the tip 122 when closed (e.g., block the flow path, etc.). In this way, the valve 118 operates to maintain the fluid in the tube 108 (within a housing) until discharge of the fluid is desired (e.g., until the valve 118 is opened, etc.).

In the illustrated embodiment, the valve 118 includes a pronged end portion 142 configured to fit within (e.g., be inserted into, etc.) the second end portion 116 of the tube 108. In doing so, prongs of the end portion 142 are configured to secure (e.g., releasably as desired, etc.) the valve 118 to the tube 108. In addition, the illustrated valve 118 includes a mounting cup 144 configured to seat the valve 118 in the cap 120 and help position the valve 118 over the outlet 106 of the body 102. Gaskets may then be positioned between the mounting cup 144 and the outlet 106 to inhibit ingress and/or egress of fluid into/from the body 102 (e.g., around the cap 120, around the valve 118, etc.).

The valve 118 also includes a stem portion 146 (e.g., a valve stem, etc.) extending along a length of the valve 118 (e.g., into the pronged end portion 142, etc.). The stem portion 146 is generally disposed in a closed position (corresponding to the closed position of the valve 118), via a spring actuator 148 (e.g., the spring actuator 148 is configured to bias the stem portion 146 to the closed position, etc.), thereby inhibiting fluid to flow from the tube 108 to the tip 122 through the valve 118. The stem portion 146 of the valve 118 is configured to generally align with the tip 122 when the tip 122 is inserted into the cap 120. As such, when the tip 122 is coupled to the cap 120 (as described above), the tip 122 engages the stem portion 146 and generally opens the valve 118 to allow fluid to flow from the tube 108 and to the tip 122 (through the valve 118). In particular, when the tip 122 is coupled to the cap 120, it pushes the stem portion 146 down and generally into the pronged end portion 142, against the spring actuator 148. In doing so, openings 150 of the stem portion 146 are moved into the fluid in the tube 108 (e.g., the openings 150 are moved from out of a sealed portion of the valve 118 and into the fluid, etc.). And, the fluid in the tube 108 begins to flow into the openings 150 and through an internal channel 152 (FIG. 6) of the stem portion 146, and then to the aligned channel 137 in the tip 122 (for delivery, discharge, etc., to the plant via port 136).

In connection with using the delivery assembly 100, in one example, the tube 108 is positioned in the body 102 and desired fluid to be introduced to a plant is contained in (or added to) the tube 108 (e.g., while the tube 108 is in the body 102, etc.) (via an access point of the body, etc.). Then (or earlier), an opening is formed in the desired plant (e.g., drilled, bored, sliced, etc.) (e.g., apart from the tip 122, for instance, to avoid crushing of tissue in the plant by the tip 122 (e.g., such that in this example the tip 122 is not self penetrating, etc.), etc.). And, the tip 122 of the delivery assembly 100 is positioned within the opening (apart from the delivery assembly 100 itself). Next, the delivery assembly 100 is coupled to the tip 122 (at the plant), for example, by snap-fitting the delivery assembly 100 to the tip 122 (via the cap 120 of the delivery assembly 100).

In doing so, the stem portion 146 of the valve 118 is actuated (e.g., depressed by the tip 122, etc.) to thereby open the valve 118, and expose the openings 150 of the stem portion 146 to the fluid in the tube 108. The tube 108 begins to automatically contract (e.g., resiliently move from the expanded state to the unexpanded state, etc.) and push, direct, etc., the fluid therein through the stem portion 146 (via the openings 150) and into the tip 122. In turn, the tip 122 directs the fluid into the opening in the plant.

In example embodiments, the tube 108 is configured (e.g., based on the size, material, etc., of the tube 108), in combination with the valve 118 and the geometry of the tip 122, to control delivery of the fluid to the plant (e.g., in a desired manner, etc.). For instance, based on a pressure of the assembly 100 (e.g., of the fluid in the tube 108, etc.) (e.g., about 0.85 bar or more or less, etc.) and a configuration (e.g., geometry, etc.) of the tip 122, the assembly 100 may deliver the fluid to the vasculature of the plant (e.g., to a particular part of the plant, etc.) (e.g., not the heartwood of the plant, etc.) and not have any pooling or settling of the fluid in the plant (e.g., the fluid is delivered to the plant in a particular manner to facilitate improved, enhanced, substantially complete, etc. utilization of the fluid by the plant; without damaging the plant; etc.). More particularly, by way of the configuration of the tip 122 (e.g., the geometry of the tip 122, etc.), the depth of delivery of the fluid into the plant is controlled, a surface area over which the fluid is delivered to/within the plant is controlled, and sealing of the fluid within the plant is controlled (e.g., to inhibit pooling and settling of the fluid in the plant, which can case damage to the inside of the plant and also make it more difficult for the plant to heal; etc.).

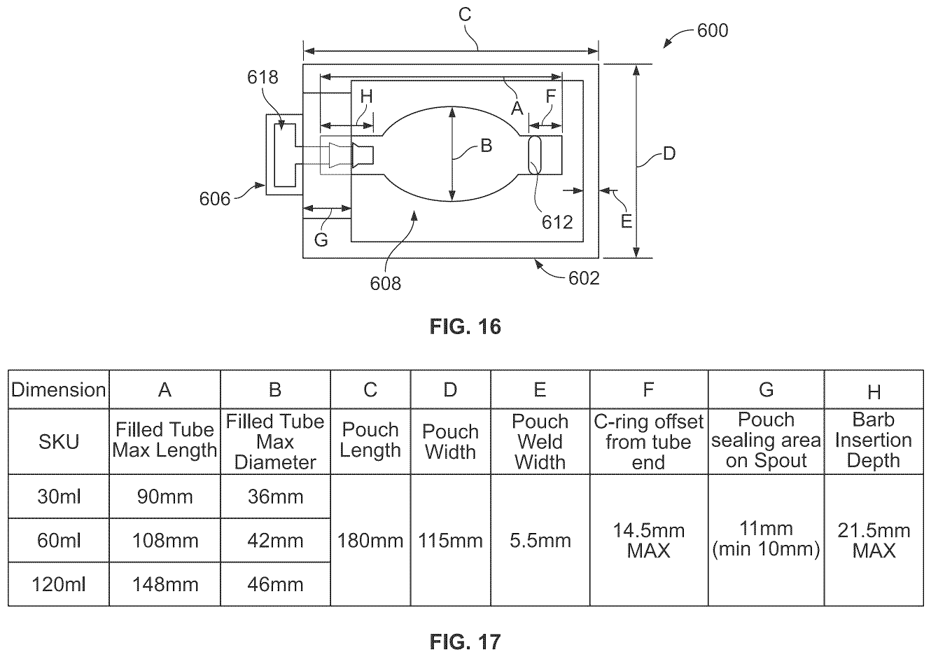

FIGS. 16-17 illustrate another example embodiment of a delivery assembly 600 of the present disclosure. The delivery assembly 600 of this embodiment is substantially the same as the delivery assembly 100 described above. In this embodiment, example dimensions are provided in FIG. 17 for different parts of the delivery assembly 600, including a body 602 (e.g., a pouch (or weld), etc.), a tube 608 and c-ring 612, and a valve 618 and corresponding outlet 606 (e.g., a spout, etc.), for different sizes, capacities, etc., of the delivery assembly 600 (e.g., for the delivery assembly 600 configured to hold 30 ml of fluid, 60 ml of fluid, and 120 ml of fluid, etc.).

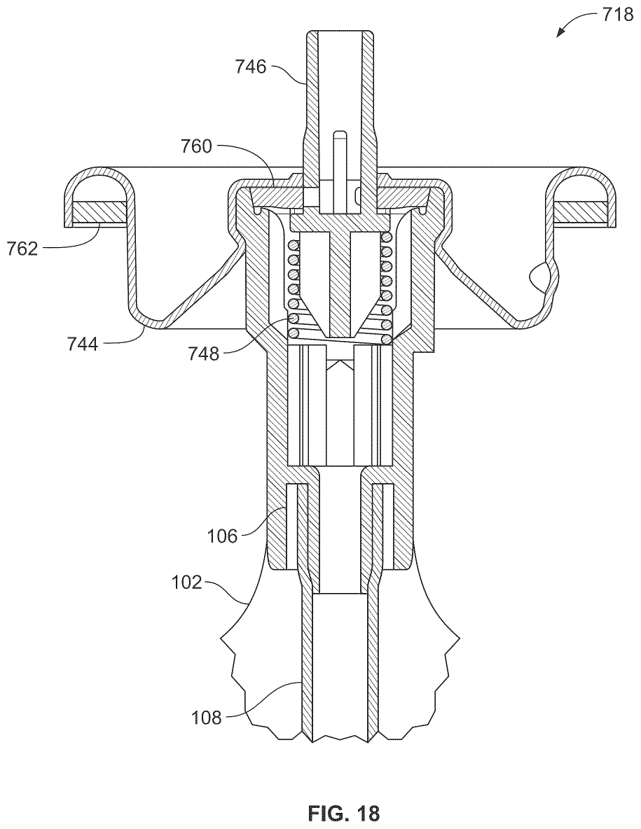

FIG. 18 illustrates an example embodiment of a valve 718 that may be used in the delivery assembly 100 of FIGS. 1-6. In connection therewith, example dimensions are provided for the valve 718 and corresponding parts thereof, including a stem portion 746, a mounting cup 744, and a spring actuator 748. In addition, the mounting cup 744 of the valve 718 is illustrated extending generally around the valve 718. As described, the mounting cup 744 is configured to seat the valve 718 in the cap 120 and help position the valve 718 over the outlet 106 of the body 102 (e.g., when the valve 718 is coupled to the tube 108, etc.). Gaskets 760, 762 are then positioned within the mounting cup 744 to generally seal the valve 718 against the body 102 and outlet 106 to inhibit ingress and/or egress of fluid into/from the body 102 (e.g., around the cap 120, around the valve 718, etc.).

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments have been provided so that this disclosure will be thorough, and will fully convey the scope to those who are skilled in the art. Numerous specific details are set forth such as examples of specific components, assemblies, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, components, and/or groups thereof, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” and the phrase “at least one of” includes any and all combinations of one or more of the associated listed items.

Although the terms first, second, third, etc., may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element, component, seed, member or section discussed below could be termed a second element, component, seed, member or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A delivery assembly for coupling to a plant and dispensing fluid into the plant, the delivery assembly comprising:
a body;
a container disposed within the body and configured to hold fluid to be dispensed into a plant;
a valve coupled in fluid communication to the container, the valve configured to retain the fluid in the container;
a tip configured to couple in fluid communication to the container and actuate the valve to transfer the fluid from the container to the tip for discharge to the plant.

2. The delivery assembly of claim 1, wherein the container is configured to resiliently expand from a first state to a second state when the fluid is in the container.

3. The delivery assembly of claim 2, wherein the container is configured to contract from the second state to the first state when the tip is coupled to the container, to thereby automatically transfer the fluid from the container to the tip for discharge to the plant.

4. The delivery assembly of claim 1, further comprising a cap coupled to the body;
wherein the valve is disposed within the cap.

5. The delivery assembly of claim 4, wherein the tip is configured to snap fit to the cap; and
wherein the cap is configured to snap fit to the body.

6. The delivery assembly of claim 5, wherein a force required to remove the tip from the cap is less than a force required to remove the cap from the body.

7. The delivery assembly of claim 6, wherein the tip includes first and second arms and an opening disposed between the first and second arms, the opening configured to discharge the fluid from the tip to the plant.

8. The delivery assembly of claim 7, wherein the tip is configured to couple to the plant, and wherein the tip includes multiple prongs configured to secure the tip to the plant.

9. The delivery assembly of claim 7, wherein the tip includes at least one rib configured to secure the tip to the container.

10. The delivery assembly of claim 7, wherein the tip increases in width from a free end of the arms to a base of the arms.

11. The delivery assembly of claim 1, wherein the valve includes a stem portion and a spring actuator, and wherein the spring actuator is configured to bias the stem portion to a closed position to thereby retain the fluid in the container; and
wherein the tip is configured to couple in fluid communication to the container and move the stem portion of the valve, against the spring actuator, from the closed position to an open position to thereby transfer the fluid from the container to the tip for discharge to the plant.

12. The delivery assembly of claim 1, wherein the fluid includes a disease treatment, an insecticide, a fungicide, a nutrient, and/or a growth promoter.

13. The delivery assembly of claim 1, wherein the tip includes first and second arms and an opening disposed between the first and second arms, the opening configured to discharge the fluid from the tip to the plant.

14. The delivery assembly of claim 1, wherein the tip is configured to couple to the plant, and wherein the tip includes multiple prongs configured to secure the tip to the plant.

15. A method for delivering fluid into a plant using a fluid delivery assembly, the method comprising:
positioning a container of the fluid delivery assembly within a body of the fluid delivery assembly;
filling the container with the fluid, while the container is positioned within the body;
installing a tip of the fluid delivery assembly to a plant;
coupling the body to the tip, while the tip is installed to the plant; and
in response to coupling the body to the tip, automatically dispensing the fluid in the container to the plant via the tip.

16. The method of claim 15, wherein automatically dispensing the fluid to the plant via the tip includes contracting the container, within the body, to transfer the fluid from the container to the tip for dispensing to the plant.

17. The method of claim 15, wherein filling the container with the fluid includes expanding the container from a first state to a second state.

18. The method of claim 17, wherein automatically dispensing the fluid to the plant via the tip includes contracting the container, within the body, from the second state to the first state to transfer the fluid from the container to the tip for dispensing to the plant.

19. The method of claim 15, wherein coupling the body to the tip includes actuating a valve, by the tip, to thereby open a flow path from the container to the tip.
